(19) United States
(12) Patent Application Publication
(10) Pub. No.: US 2022/0108591 A1
(43) Pub. Date: Apr. 7, 2022

(54) ATM Frauds Detection by Machine Learning System: SentryWare and SentryManager

(71) Applicant: Pranav Jayabalan, Sunnyvale, CA (US)

(72) Inventor: Pranav Jayabalan, Sunnyvale, CA (US)

(21) Appl. No.: 17/500,867

(22) Filed: Oct. 13, 2021

(51) Int. Cl. G07F 19/00; G06Q 20/10; G06Q 20/40; G06N 20/00

(52) U.S. Cl. CPC G07F 19/2055; G07F 19/209; G07F 19/207; G06N 20/00; G06Q 20/4016; G06Q 20/407; G06Q 20/1085

(57) ABSTRACT

A SentryWare apparatus comprising Vibration/Accelerometer Sensors deployed on ATM Cash Dispenser, ATM Card Reader, ATM Cash Reject Bin, ATM Cash Tray, ATM Cash Dispenser Door, ATM base, and ATM card intake, Electric/Magnetic (Reed) Switch sensors deployed at Network Cable-Modem interface, Network Cable-Computer interface, Hard Disk Drive-Computer interface, ATM Keyboard Cable-Computer Interface, Power Clamp meter wrapped around the power cable serving the ATM cash dispenser, and NEC sensor deployed near the NEC reader of the ATM is used to detect bank ATM frauds. The sentryWare apparatus has a microcontroller that can read sensor data from which bank ATM frauds can be deduced.

[Problem to be solved]: Billions of dollars are lost around the world due to ATM (Automated Teller Machine) fraud. These frauds need to be detected and stopped. The ATM frauds are:
1. Skimming: Fraudsters attach a wireless device to the ATM card reader, which reads the personal and card information on the magnetic stripe of the cards that are used at the ATM.
2. Shimming: Fraudsters insert a thin electronic device inside the ATM card reader so that the data read and written to the EMV (Europay, Mastercard, and Visa) chip on the ATM/Credit card can be accessed by the fraudsters. This enables them to duplicate the ATM/Credit card with EMV data.
3. Jackpotting: Fraudsters either connect a black box to the cash dispenser of the ATM, access the ATM network by tapping the network cable, or installing a virus onto the ATM computer. This will enable them to access the cash dispenser of the ATM. The fraudsters can then activate the cash dispenser to dispense cash on demand.
4. Internal Service Person Theft: ATM service representatives who either steal directly from the cash dispenser or alter the BIOS/Hard Disk image(OS) in the ATM.
5. ATM Theft: The ATM itself can be stolen. One of the dangerous methods fraudsters use is to place explosives into the ATM, explode it, and then get away with the cash dispenser.
6. Network cable, Keyboard, Hard Disk, NFC Card Reader and other ATM Computer component Tampering: Fraudsters physically tamper with the ATM so that they can attach a keyboard or access the network cable so that they can install a virus software or replace the hard disk on the ATM computer with a virus on it or tamper with any other component of the ATM computer.
7. Transaction Reversal: The fraudster initiates a cash dispense transaction. However, in the middle of the cash dispensing, the fraudster can terminate the transaction by pulling out the ATM card but access the cash before the cash is returned to the reject bin of the cash dispenser.
8. Cash Trapping: Fraudsters attach a device to the ATM cash dispenser and divert any cash dispensed into that device. This leads the actual customer not to receive money as it gets trapped into the device. The fraudster can then retrieve the money after the customer is gone.

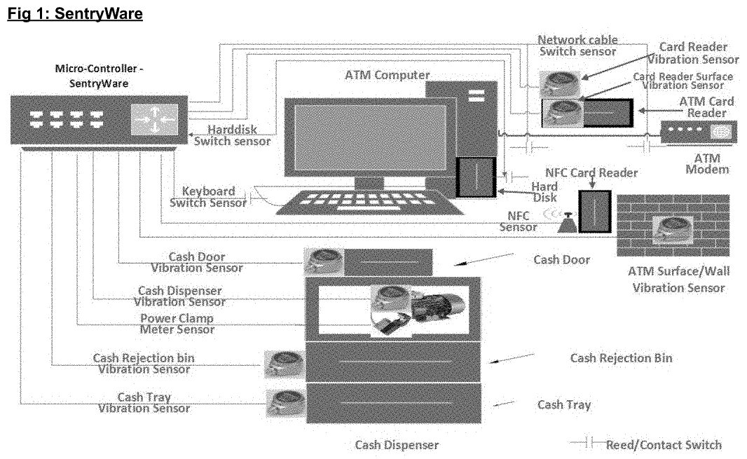

SentryWare (FIG. 1), which comprises a micro-controller attached to multiple sensors, can self-learn (machine learning) and identify all the ATM fraudulent activities identified above. An out-of-band (as opposed to deploying an application within the ATM computer that integrates with the ATM applications), Machine Learning solution is proposed for each of the above problems. This solution can be enhanced to handle any future problems as well. There is one SentryWare deployed per ATM.

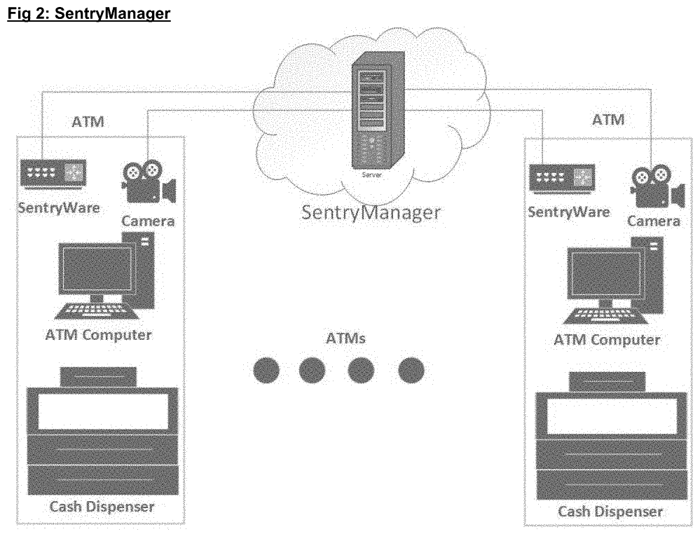

SentryManager (FIG. 2), a Deep Learning software deployed on a central server, is connected to all the ATM Cameras. The deep learning software for computer vision is used to process video data to assess ATM fraudulent activities. Also, all the SentryWares are managed (for machine learning) by the SentryManager.

First part of this patent is about auto-generation of datasets (“labeled dataset” in machine learning parlance) from the sensors for Machine Learning. ATM computers have computer log files called journals which log every user and ATM activity such as customers inserting a card, authenticating the card, requesting cash, etc, and the ATM completing the cash/card dispense, etc. The sensors data collection is always active in both learning and inference mode. However, in the learning mode, the data set is automatically extracted from the collected sensor data based on the time stamp on the journal log for each activity. For example, if a “card read” activity is logged at time t in the journal, data will be extracted around time t (from collected sensor data) and automatically create a labeled dataset for “card reading”. A few of these datasets can then be used for Supervised learning and validating (for “Card Reading” activity). Once machine-learnt, the Machine-learnt model can then be used to infer the current sensor data to detect the ATM activity. If the activity detected is not in compliance with journal log or other Bank ATM data, a fraudulent alert is generated. The core of the patent is about the set of data that is collected:
1. Vibration Sensor Data: A vibration sensor is placed on the ATM card reader and the vibration signal is collected from this sensor periodically by the SentryWare. Based on this sensor data, “card insert/eject” activity can be learned as described above. Any unlearned signal (that excludes impulse signals and baseline signals) on this sensor can be construed as “Shimming”.
2. Electric/Magnetic Sensor Data: Electric/Magnetic switches (Reed Switch, similar to the door contact switch) are used to detect tampering of the ATM computer components . A power clamp meter can also be used to measure the electric power consumed by the Cash dispenser to detect its activity. NFC (near field communication) Sensor can be used to detect hacking via the NFC reader.
3. Camera Data: Most ATMs are equipped with a camera. The camera data can be extracted and Computer Vision Deep Learning Models can be applied to the video. For example, the “cash dispense” entry in the journal log at time t is used to extract video data around time t, and from this data set, Deep Learning Models are learned to identify “cash withdrawal” activity. Once the deep learning model is learnt, subsequent video data is inferred to identify cash withdrawal. If the deep-learnt model detects cash withdrawal activity and there is no corresponding journal/switch/bank log entry for cash withdrawal, a Jackpotting fraud alarm is raised.

### DESCRIPTION

### Vibration Sensors

Whenever physical ATM activities are triggered, there is an associated vibration. A vibration sensor is placed on the ATM at appropriate locations and the vibration is measured using a micro-controller called Sentryware, which performs vibration analysis and sends results to a Central Manager called SentryManager.

### Vibration Analysis

The time waveform of the vibration data is collected from which the frequency spectrum (using Fast Fourier Transform) of the vibration is computed and recorded in the SentryWare. For example, vibration analysis for “Cash Dispenser Sensor” is done as follows: Baseline frequency spectrum is computed to identify the non-activity of the cash dispenser. This would be done, for example, dusk to dawn and can be verified during machine learning by checking journal logs to ensure no transactions were made during that time. Active frequency spectrum information is computed from the collected vibration sensor data during the time of the Cash Dispenser dispensing cash. This time can be obtained from the journal log entry (for cash dispensing). Thus the time waveform and frequency spectrum analysis data set recorded during the time of cash dispenser activity are “machine-learnt” for future reference. Once the learning is done, the vibration analysis machine learnt model can be inferred with the current vibration data to determine if the cash dispenser is active, independent of the journal log. The SentryWare can then forward the cash dispenser activity to the SentryManager. The SentryManager can then validate the SentryWare's cash dispenser data with the journal log data (or bank transaction/switch log). If the validation has a high number of matches, then the SentryWare has learnt to detect cash dispenser activation. If the validation has many mismatches, then the SentryWare can be forced to relearn the cash dispenser activity. Once the SentryWare has learnt the cash dispenser activity from the vibration sensor data, it then notifies the SentryManager whenever there is a cash transaction. The SentryManager can verify with journal/switch log (or other means) if a cash transaction was approved. If not, a “Jackpotting” alert is generated. The alert can then be verified by analyzing the security video for the ATM for any jackpotting activity.

Similarly, a vibration sensor placed on the cash tray holder, would provide a dataset to learn, validate and relearn the loading/unloading of the cash tray into the cash dispenser. This activity is verified with the work log for the ATM. So, whenever inference of this vibration sensor data indicates loading/unloading of the cash tray and there is no work log entry for a service member to access the ATM that day, the sensor alert will be triggered as “Internal Theft” and will need to be verified with the internal/security camera.

Similarly, a vibration sensor placed on the cash reject bin, would provide a dataset to learn, validate and relearn the rejection of cash into the cash rejection bin. This activity is verified with the journal log of the ATM for transaction reversal. So, whenever a cash transaction is rejected after the initiation of cash transaction (the initiation would also be identified by the vibration sensor on the cash dispenser) as identified by the journal log and the lack of corresponding detection of cash getting into the cash rejection bin (as should have been detected by the sensor on the cash rejection bin) is inferred to as Transaction Cash Reversal Fraud. This fraud can be verified with the internal/security camera.

Likewise, a vibration sensor placed on the card reader would provide a dataset to learn, validate and relearn the insertion or removal of ATM cards in the ATM card reader. ATM Card activity is verified with the journal log. So, whenever inference of this vibration sensor data indicates insert/removal of the ATM card and there is no journal log entry for card insert/removal at that time, the sensor alert will be triggered as “Shimming” and can be verified with the security camera.

Likewise, a vibration sensor placed near the card reader intake would provide dataset to learn/validate/relearn the insertion/.removal of ATM card in the card reader. ATM Card activity is verified with the journal log. So, whenever inference of this vibration sensor data indicates “activity” and there is no corresponding journal entry for ATM card, then a sensor alert for Skimming is generated and ATM activity needs to be verified with the security camera.

Likewise, a sensor placed on the cash door of the cash dispenser, would provide datasets to learn/validate/relearn the cash dispensed at the output of the cash dispenser. This activity is verified with the journal log of the ATM for cash dispensing. So, whenever a cash transaction is initiated (the initiation would also be identified by the vibration sensor on the cash dispenser) as identified by the journal log and the lack of corresponding detection of cash getting into the cash dispenser door (as should have been detected by the sensor on the cash dispenser door) is inferred as Cash Trapping.

Sensors can also be placed appropriately to detect ATM theft. In this case, vibrations would be generated when a tow-truck is trying to lift the ATM or when the ATM is hacked with a hammer to deploy explosives to access the cash dispenser. In this scenario, the vibrations can only be compared with the base line spectrum. Hence, this sensor will need to be chosen appropriately (like sensitivity and frequency response of the sensor) and time waveform analysis of the sensor will need to be done.

### Electric/Magnetic Sensors

The most important asset of the ATM that needs to be protected is cash. Hence, an additional cash dispenser sensor (besides the vibration sensor) can be used. It would be an electrical power clamp meter that measures the electrical power used by the cash dispenser. The sensor would wrap around the power cable supplying power to the cash dispenser. During non-activity, the power used by the cash dispenser would be minimal but will increase when cash is dispensed. Similar to the vibration sensor machine learning for cash dispenser activity, the cash dispenser activity can be learnt using the power clamp meter as well. Thus, a power clamp meter can be used to detect Jackpotting.

Also, a contact Electric/Magnetic switch (a reed switch, as in door/window contact switch) can be used to detect tampering with ATM computer components. To detect Network Cable tampering, a reed switch is connected to the modem/computer and the network cable. Whenever, the network cable is removed from the modem/computer, the switch would send a digital signal which can be read by the SentryWare as network cable tampering. Similarly, the tampering of Keyboard/Keyboard cable, the Hard Disk or any other component of the ATM computer can be detected using a contact/reed switch. These switch signals are read as on/off values and hence will not require machine learning.

NFC (near field communication) cards are starting to be used in the ATMs. A NFC sensor, placed near the NFC reader of the ATM, can detect NFC communication with the ATM that can be read by the SentryWare (connected to the NFC sensor) and the time waveform information fed to the SentryManager. The SentryManager can verify with the journal/switch logs or other means to verify that there was indeed a NFC ATM card transaction and then learn/validate/relearn from the NFC sensor dataset. After learning, If NFC communication is detected by the NFC sensor and If there is no card validation record found or the NFC communication is longer than usual, then NFC tampering is identified and verified through the security camera.

Camera/Video Processing: Computer Vision Deep Learning: As described in the Camera Data section above, Video data can be learnt and processed for Jackpotting and Cash Trapping detection. For example, the “cash dispense” entry in the journal log at time t is used to extract video data around time t, and from this data set, Deep Learning Models are learned to identify “cash withdrawal” activity. Once the deep learning model is learnt, subsequent video data is inferred to identify cash withdrawal. If the deep-learnt model detects cash withdrawal activity and there is no corresponding journal/switch/bank log entry for cash withdrawal, a Jackpotting fraud alarm is raised. Similarly, Deep learning models can be learned to detect “card insert” activity. Video data can be inferred with the“card insert” deep learned model and if a “card insert” activity is detected without a corresponding “card entry” in the journal/switch log or a long duration of the “card insert” activity is detected, then Skimming or Shimming fraud alert is triggered. Finally, a Deep learning model can be built to detect facial masks. When a customer approaching the ATM with a facial mask is detected by this deep learning model, an early warning alert of ATM Theft/Fraud is generated. All of these detected frauds can be verified by checking the security camera. Thus a video processing deep learning model can detect Jackpotting, Cash Trapping, Skimming, Shimming and early detection of ATM theft/fraud. If too many false positives or true negatives are identified (i.e when the SentryManager detection does not match the journal/bank records), then the deep learning model can be forced to relearn. Moreover, because video processing requires intense computing, it is done in the SentryManager.

### Disclosure of the Invention

The significance of this patent is machine/self-learning and the usage of sensors and camera data for machine learning to detect ATM frauds. The SentryWare can learn, validate, and relearn each of the ATM activity independently and automatically. The need for self-learning is essential because the vibration level, sensor preload, temperature and environment effect on the sensor are unique to each deployment and therefore, can not be pre-programmed out-of-the-factory or as a one time installation procedure. The baseline and active data set are learnt based on the ATM journal entries and the entries' timing. Once learnt, self-learnt data model can be used to detect ATM activity and verified with other bank/atm records. If fraudulent activity is detected, the security camera can be audited for confirmation of the fraud. If there are too many false positives or true negatives (i.e when the SentryWare detection does not match the journal/bank records), the system can automatically trigger relearning. The relearning usually happens when there is a change in ATM deployment (for example, the ATM could be redeployed in a different location that could affect sensor response), change in the ATM components (change in the material of the cash tray would alter sensor response) etc.

### Means for Solving the Problems

The first step in solving a problem is to identify the problem as early as possible. Once the frauds are identified, the following possible solutions can be applied:
1. Skimming and Shimming: If the timing of Skimming and Shimming is known, then all compromised cards can be identified through the journal log. The bank can then invalidate those cards and reissue new cards. The bank can also schedule a service to remove the skimming and shimming device so that future customer cards are not compromised.
2. Jackpotting, Transaction Reversal, Cash Trapping: Once the fraudulent activities of Jackpotting, Transaction Reversal and cash trapping are discovered by the SentryWare/SentryManager Video processor, the SentryManager raises an alert/ticket (in a third party ticketing application). These tickets can then be verified through the security camera. Either through operator intervention or through automatic triggers, the SentryManager can power down the cash dispenser and/or the ATM through a network switched PDU (Power distribution unit). i.e the SentryManager/SentryWare would automatically log into the PDU web application and power down the outlets to which the Cash Dispenser and ATM computer are connected to. This would disable cash availability at the ATM. Services can be requested to fix the issue like virus elimination (if Jackpotting is enabled through ATM computer virus) or removal of the attached “jackpotting” device. Importantly, SentryWare will be able to detect viruses installed in the ATM computer (if a virus is used in Jackpotting).
3. ATM Tampering: Whenever ATM tampering is reported by the SentryWare and verified through the security camera, the ATM can be powered down through the network switched PDU, Powering down of the ATM will protect both the tampered ATM and other ATMs deployed in the network (for example, in case of ATM network cable tampering).
4. ATM Theft: When the SentryManager Video processor or the SentryWare detects ATM theft as early as possible (i.e when a masked customer is detected or the initial vibration of the whole ATM is sensed) and is verified via the security camera, remedial actions can be taken. For example, loud sirens can be played or dyes can be released into the cash tray by the SentryWare so that the cash becomes unusable, thus discouraging future theft.
5. Internal Theft: When the SentryWare detects internal theft, the alert can be verified via internal security camera and appropriate legal actions pursued.

Advantages of the Invention: First and foremost, all the known fraudulent activities in the ATM can be detected and rectified. The invention/idea can also be extended to newer fraudulent activity by adding appropriate sensors. Secondly, the self-learning capability of the SentryWare enables the solution to learn/validate/relearn the ATM activity as the environment changes. This adaptive solution is a better solution compared to a static solution as static solutions will generate too many false positives and true negatives and are incorrigible. Interestingly, this out-of-band solution can detect a Jackpot malware in the ATM computer which probably was not detected by the antivirus software installed in the ATM.

Finally, a micro-controller/SentryWare based solution will enable the solution to be deployed as out of band deployment (as opposed to deploying a solution inside the ATM computer as another application which integrates with other ATM applications). This offers the following benefits: there is a chance that fraudsters can power down the system and/or disable the network and then commit the theft/fraud. A micro-controller can be powered independently on a Lithium-ion battery for a few hours. The micro-controllers can also be configured to communicate via pager technology (which is cheap on the bulk purchase). Thus, they can function independent of ATM power and network when needed. This allows SentryWare to continue detecting fraud during critical moments and take corrective actions if needed.

1. A SentryWare Apparatus comprising:
a. Vibration/Accelerometer Sensors deployed on ATM Cash Dispenser, ATM Card Reader, ATM Cash Reject Bin, ATM Cash Tray, ATM Cash Dispenser Door, ATM base and ATM card intake.
b. Electric/Magnetic (Reed) Switch deployed at Network Cable-Modem interface, Network Cable - Computer interface, Hard Disk Drive-Computer interface, ATM Keyboard Cable-Computer Interface.
c. Power Clamp meter wrapped around the power cable serving the ATM cash dispenser.
d. NFC sensor deployed near the NFC reader of the ATM.
e. All the necessary electrical circuits to receive data signal from the sensors identified in claim 1 are incorporated in the SentryWare.
f. A micro-controller that can read and write sensors data and have sufficient computing resources for implementing machine learning algorithms.

2. Machine Learning Software that:
a. Learns and Validates ATM activities via supervised learning from the data of sensors identified in claim 1 and described in the “Description” of the patent.
b. Infers the sensors' data to detect ATM activity and thus identify Jackpotting, Skimming, Shimming, Transaction Reversal Fraud, Cash Trapping, ATM Tampering (like network cable, keyboard and Hard Disk tampering), Cash Theft and ATM tampering by Service People and ATM/Cash Dispenser theft.

3. Automatically relearn claim 2 if significant False Positive or True Negatives are generated by SentryWare when verified with the journal log/bank records.

4. Deep Learning Computer Vision Software that:
a. Learns and Validates ATM activities via supervised learning from the Video data of the internal camera of the ATM as described in the description of the patent
b. Infers video data to identify Jackpotting, Skimming, Shimming and Early warning of ATM fraud/theft.

5. Automatically relearn claim 4 if significant False Positive or True Negatives are generated by SentryManager when verified with the Security Camera/journal log of the ATM.

6. When claims 2 and 4 detect fraudulent activity at the ATM, SentryWare/SentryManager can power down the Cash Dispenser and/or the ATM computer. To achieve this, the ATM Computer and the Cash Dispenser needs to be connected to a network switched PDU and SentryWare/SentryManager needs to be on the local network of the PDU. The SentryWare/SentryManager can then power the ATM Computer/Cash Dispenser down through the web application of the networked PDU, Also, SentryWare can play loud siren or release dyes into the cash tray to make the cash worthless.
